(19) United States
(12) Patent Application Publication
(10) Pub. No.: US 2014/0215496 A1
(43) Pub. Date: Jul. 31, 2014

(54) DEVICE INCLUDING A PLURALITY OF FUNCTIONALITIES, AND METHOD OF OPERATING THE DEVICE

(71) Applicant: NEXOVATION, INC., Hendersonville, TN (US)

(72) Inventors: Robert J. Sexton, Hendersonville, TN (US); John Sherriff, Incline Village, NV (US); Caroline E. Sexton, Hendersonville, TN (US)

(73) Assignee: NEXOVATION, INC., Hendersonville, TN (US)

(21) Appl. No.: 14/167,991

(22) Filed: Jan. 29, 2014

Related U.S. Application Data
(60) Provisional application No. 61/758,164, filed on Jan. 29, 2013.
(60) Provisional application No. 61/764,813, filed on Feb. 14, 2013.

(51) Int. Cl. G06F 9/54

(52) U.S. Cl. CPC G06F 9/542
USPC 719/318

(57) ABSTRACT

A device having a plurality of functionalities includes an event detector for detecting a functionality setting event, a functionality setting device for referring to functionality data and setting a first functionality of the plurality of functionalities based on the functionality data, and a controller for controlling a feature associated with the first functionality to be operable in response to the setting of the first functionality.

### BACKGROUND OF THE INVENTION

1. Field of the Invention

The present invention relates to a device having a plurality of functionalities, and more particularly, a device which refers to functionality data to set a functionality of the device.

2. Description of the Related Art

Traditionally, cellular phones, smart phones, mobile computing devices, laptops, tablets, personal computers, personal digital assistants (PDAs) or other devices enable the user to lock the device or suspend a functional element (e.g., display screen) of the device. Such devices include, for example, iPhone, iPad, Android, e-readers, video gaming, laptop or other computers, etc.

In addition, there is a growing number other devices that provide an electronic “lock” feature that allows the user to “lock” a functional element of the device. For example, a growing number of vehicles, weapons, large appliances (e.g., refrigerators, washers and dryers, etc.) and small appliances provide such an electronic lock feature.

Typically, the user of these devices (e.g., lockable devices) uses the “settings” feature of the device in order to select a “lock” mode. In response to selecting the “lock” mode, the user is then prompted to enter a symbol, passcode or password which may be used to unlock the device at start-up or once the device has been idle for a given period of time.

That is, conventional devices typically offer the user only two modes “locked” or “unlocked”.

### SUMMARY

In view of the foregoing and other problems, disadvantages, and drawbacks of the aforementioned conventional systems and methods, an exemplary aspect of the present invention is directed to a device having a plurality of functionalities.

An exemplary aspect of the present invention is directed to a device having a plurality of functionalities. The device includes an event detector for detecting a functionality setting event, a functionality setting device for referring to functionality data and setting a first functionality of the plurality of functionalities based on the functionality data, and a controller for controlling a feature associated with the first functionality to be operable in response to the setting of the first functionality.

Another exemplary aspect of the present invention is directed to a method of operating a device including a plurality of functionalities. The method includes detecting a functionality setting event, referring to functionality data and setting a first functionality of the plurality of functionalities based on the functionality data, and controlling a feature associated with the first functionality to be operable in response to the setting of the first functionality.

Another exemplary aspect of the present invention is directed to a programmable storage medium tangibly embodying a program of machine-readable instructions executable by a digital processing apparatus to perform a method of operating a device including a plurality of functionalities. The method includes detecting a functionality setting event, referring to functionality data and setting a first functionality of the plurality of functionalities based on the functionality data, and controlling a feature associated with the first functionality to be operable in response to the setting of the first functionality.

With its unique and novel features, the present invention provides a device in which functionalities are more easily enabled as compared to conventional devices.

### BRIEF DESCRIPTION OF THE DRAWINGS

The foregoing and other objects, aspects and advantages will be better understood from the following detailed description of the embodiments of the invention with reference to the drawings, in which:

FIG. 1 illustrates a device 100, in accordance with an exemplary aspect of the present invention;

FIG. 2 illustrates a method 200 of operating a device including a plurality of functionalities, according to another exemplary aspect of the present invention;

FIGS. 3A-3B illustrate a user device 300, according to another exemplary aspect of the present invention;

FIGS. 4A-4B illustrate a user device 400, according to another exemplary aspect of the present invention;

FIG. 5 illustrates functionality data 500, according to an exemplary aspect of the present invention;

FIG. 6 illustrates a device 600 (e.g., a device having the features of device 100, 300, 400), including a display screen 601 that may be displayed, for example, on a device according to another exemplary aspect of the present invention;

FIG. 7 illustrates a device 700 (e.g., a device having the features of device 100, 300, 400), according to another exemplary aspect of the present invention;

FIG. 8 illustrates a device 800 (e.g., a device having the features of device 100, 300, 400 or 600), according to another exemplary aspect of the present invention;

FIG. 9 illustrates a device 900 (e.g., a device having the features of device 100, 300, 400, 700), according to another exemplary aspect of the present invention;

FIG. 10 illustrates six examples 1010, 1020, 1030, 1040, 1050 and 1060 of an exemplary Trace Symbol input methodology for a device (e.g., a device having the features of device 100, 300, 400, 600 or 700), according to another exemplary aspect of the present invention;

FIG. 11 illustrates a typical hardware configuration 1100 that may be used to implement the device (e.g., device 100, 300, 400, 600 and 700) and method (e.g., method 200), in accordance with an exemplary aspect of the present invention; and

FIG. 12 illustrates a magnetic data storage diskette 1200 and compact disc (CD) 1202 that may be used to store instructions for performing the inventive method of the present invention (e.g., method 200), in accordance with an exemplary aspect of the present invention.

### DETAILED DESCRIPTION OF SOME EXEMPLARY EMBODIMENTS OF THE INVENTION

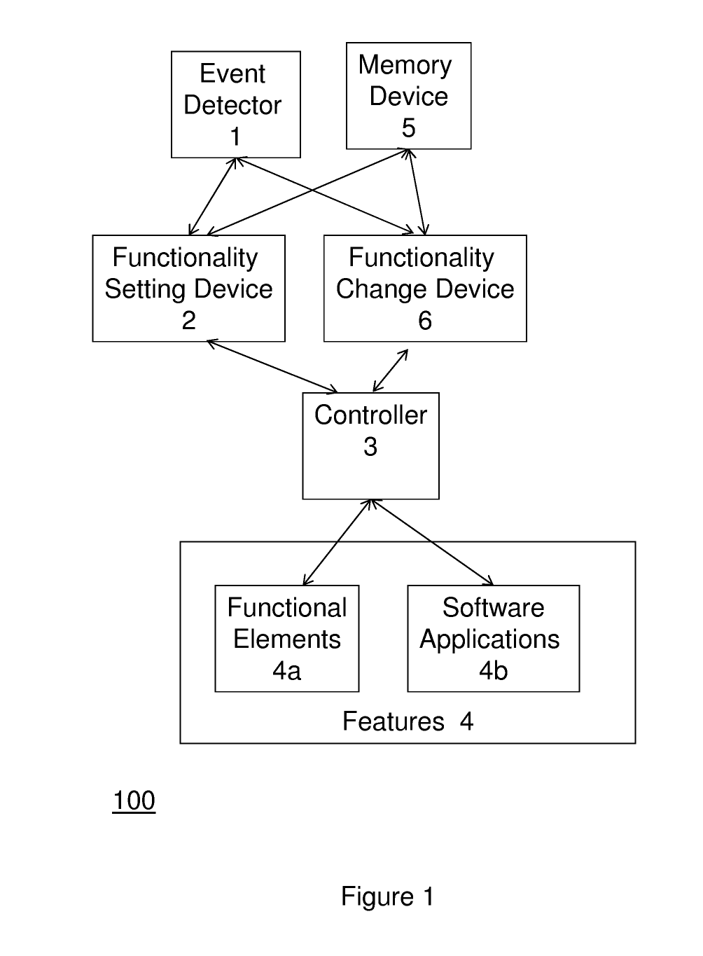

Referring now to the drawings, FIGS. 1-12 illustrate the exemplary aspects of the present invention.

FIG. 1 illustrates a device 100 including a plurality of functionalities, according to an exemplary aspect of the present invention.

As illustrated in FIG. 1, the device 100 includes an event detector 1 for detecting a functionality setting event, a functionality setting device 2 for referring to functionality data (e.g., user programmable functionality data) and setting a first functionality of the plurality of functionalities based on the functionality data, and a controller 3 for controlling a feature 4 associated with the first functionality to be operable in response to the setting of the first functionality.

As also illustrated in FIG. 1, the device 100 may also include a memory device 5 for storing the functionality data, the functionality data associating the detected functionality setting event with the first functionality, and associating the first functionality with the feature 4. In particular, the functionality data may associate the first functionality with a plurality of features of the device 100, and may associate a plurality of functionality setting events with the plurality of features.

More specifically, the device 100 may include a plurality of features including a plurality of functional elements 4a (e.g., a display element, a camera element, a telephone element, a flashlight element, a speaker element, a microphone element, a location determination element, an element for managing network access (e.g., an element for accessing the Internet, a local area network, a blue tooth connection to other devices, etc.), and a plurality of software applications 4b (e.g., an Internet browser application, a music application, a calendar application, a mapping application, a settings application, an e-mail browser application, a weather application, a calculator application, etc.).

The plurality of functionality setting events may include one or more of entering a passcode, fingerprint recognition, voice recognition, facial recognition, shaking the device, the device leaving a geographical location and the device entering a geographical location.

Referring again to FIG. 1, the event detector 1 may also detect a functionality change event, and the functionality data may associate the detected functionality change event with a second functionality of the plurality of functionalities, and may associate the second functionality with an other feature of the device. That is, the functionality change event may be considered to be an event which, if detected by the event detector 1, will cause the device 100 to change (e.g., dynamically change) the functionality of the device 100.

A functionality change event may include, for example, entry of a manual command for changing a functionality, dropping the device 100, entering a predetermined address in an Internet browser application, sending a voice message to a pre-determined phone number and/or email address or other messaging system, sending an e-mail to a predetermined e-mail address in a e-mail application, sending a text to a predetermined number, receiving a text from a predetermined number, operating a functional element (e.g., display device) at a predetermined time of day, operating a software application at a predetermined time of day, etc. Thus, for example, the device 100 may be programmed by the user so that if a particular website (or type of website) is visited by the user, the event detector 1 will detect this, so that the controller 3 will change the functionality of the device 100 to a different functionality (e.g., a “complete lock” functionality which denies access to any feature on the device—i.e., the device is completely locked).

Further, the device 100 may include a functionality change device 6 for referring to the functionality data to change the functionality of the device 100 from the first functionality to the second functionality, in response to the event detector 1 detecting the functionality change event, and the controller 3 may control the second feature to be operable, in response to the functionality change device 6 changing the functionality of the device 100 to the second functionality.

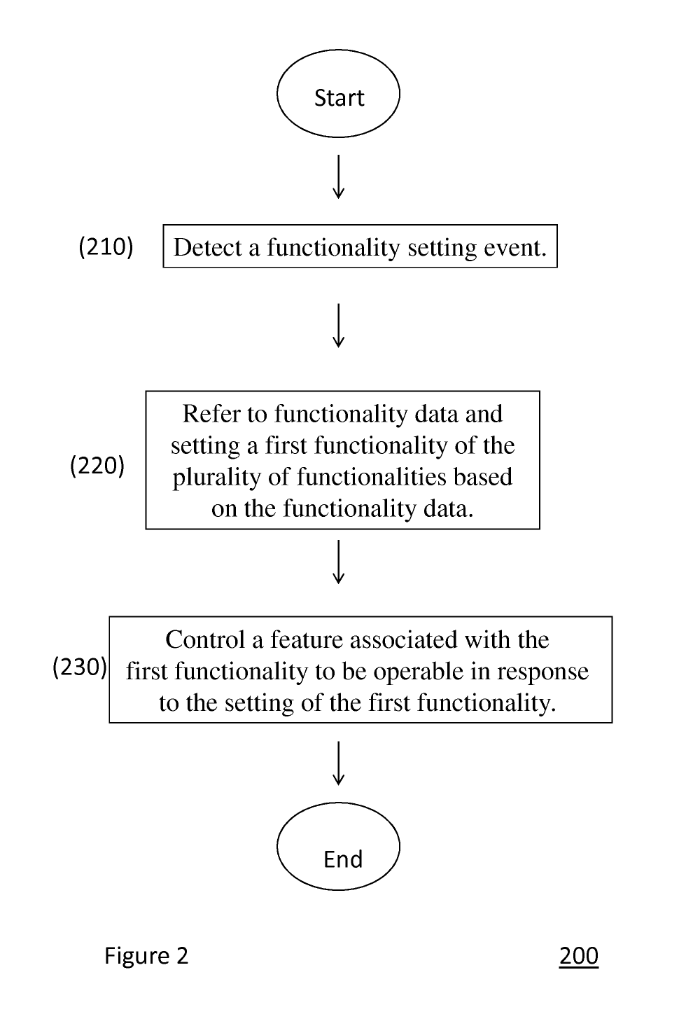

FIG. 2 illustrates a method 200 of operating a device including a plurality of functionalities, according to another exemplary aspect of the present invention.

As illustrated in FIG. 2, the method 200 includes detecting (210) a functionality setting event, referring (220) to functionality data and setting a first functionality of the plurality of functionalities based on the functionality data, and controlling (230) a feature associated with the first functionality to be operable in response to the setting of the first functionality.

Further, the method 200 may also include determining (240) the mode to which the user would like to return. The determining (240) may be performed, for example, after the controlling (230) of the feature. In particular, the determining (240) may include asking whether the user wants the device to go back to a lock mode or back to an unlock mode. For example, the controller 3 may control the display of the device to display a mode selection screen which prompts the user to input the mode to which the user would like to return.

The method 200 may also include storing (e.g., in the memory device 5) the functionality data, the functionality data associating the detected functionality setting event with the first functionality, and associating the first functionality with the feature. The method 200 may also include displaying a functionality data manipulating screen (e.g., on a display element of function elements 4a) which includes a functionality input section, a functionality change event input section, an account input section, functionality initiated and an operable feature input section.

The method 200 may also include detecting a functionality change event, the functionality data associating the detected functionality change event with a second functionality of the plurality of functionalities, and referring to the functionality data to change the functionality of the device 100 from the first functionality to the second functionality, in response to the event detector 1 detecting the functionality change event.

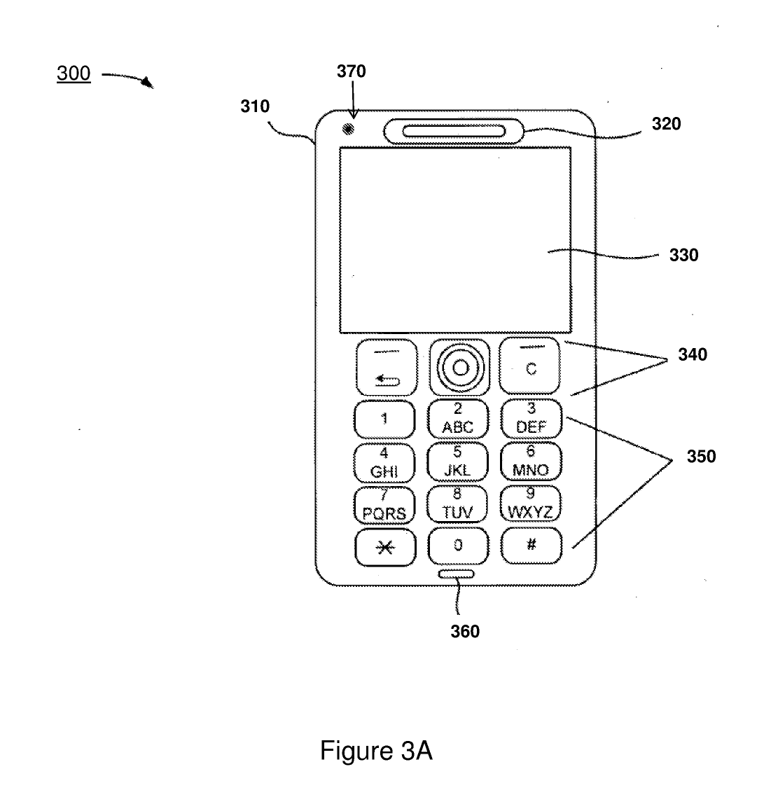

FIGS. 3A-3B illustrate a user device 300 according to another exemplary aspect of the present invention. The user device 300 may include all of the features and functions described above with respect to device 100.

As illustrated in FIG. 3A, the user device 300 may include a mobile terminal (e.g., “pervasive computing” device). The term “mobile terminal” may include, for example, a cellular telephone with or without a multi-line display; a Personal Communications System (PCS) terminal that may combine a cellular radiotelephone with data processing, facsimile and data communications capabilities; a computer; a tablet; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. The device 300 may also be configured to add other input/output devices that might measure heart rate, sound levels, light levels, for example. This is covered somewhat in the next paragraph.

The user device 300 may also include, for example, a device which includes an electronic lock feature which may be used to lock or unlock one or more features of the device (e.g., prevent operation of one or more features of the device).

In particular, the electronic lock feature may have a plurality of lock levels with varying levels of security. For example, the lock levels may be a functionality of the present invention that may be set or changed. The lock levels may range in security level, for example, from an “unlocked” level to a “complete lock” level (e.g., no functions or software applications are available to a user), and include an unlimited number of levels therebetween which may be configurable by the user.

In particular, the user device 300 may include any device that displays information and allows users to interact with the displayed information with or without including various other communication functionality. For example, user device 300 may include a personal computer (PC), a laptop computer, a personal digital assistant (PDA), a media playing device (e.g., an MPEG audio layer 3 (MP3) player, a video game playing device), an appliance (e.g., a refrigerator) a global positioning system (GPS) device, etc., that may not include various communication functionality for communicating with other devices.

As illustrated in FIG. 3A, the user device 300 may include one or more of the following: a housing 310, a speaker 320, a display 330, control buttons 340, a keypad 350, and a microphone 360. Housing 310 may protect the components of user device 300 from outside elements. Speaker 320 may provide audible information to a user of user device 300.

The user device 300 may also include an image capturing device 370 to provide the device 300 with the features of a still camera and/or a video camera.

Display 330 may provide visual information to the user. For example, display 330 may display information regarding incoming or outgoing telephone calls, electronic mail (e-mail), instant messages, short message service (SMS) messages, etc. Display 330 may also display information regarding various applications, such as a messaging or notes application stored in user device 300, a phone book/contact list stored in user device 300, the current time, video games being played by a user, downloaded content (e.g., news or other information), songs being played by the user, etc.

In an exemplary implementation, display 330 may include a touch screen display device that allows a user to enter commands and/or information via a finger, a stylus, a mouse, a pointing device, or some other device. For example, display 330 may be a resistive touch screen, a capacitive touch screen, an optical touch screen, an infrared touch screen, a surface acoustic wave touch screen, or any other type of touch screen device that registers an input based on a contact with the display 330.

Control buttons 340 may permit the user to interact with user device 300 to cause user device 300 to perform one or more operations, such as place a telephone call, play various media, etc. In an exemplary implementation, control buttons 340 may include one or more buttons that controls various applications and features associated with display 330. For example, one or more of control buttons 340 may be used to initiate execution of an application program that permits a user to configure options associated with displaying information while display 330 is in a lockscreen mode.

Keypad 350 may include keys which may or may not be similar to the keys of a standard telephone keypad. That is, for example, the keypad could be all characters with no numbers, all numbers with no characters, etc. Microphone 360 may receive audible information from the user for activating applications or routines stored within user device 300.

It should be noted that the control buttons and/or the keypad 350 may be “virtually” provided as an image on the display 330 (e.g., touchscreen display) instead of being structurally provided as a “button” on the face of the device 300.

FIG. 3B illustrates a functional block diagram including components that may be included in the user device 300, according to another exemplary aspect of the present invention.

As illustrated in FIG. 3B, the user device 300 may include bus 380, processor 381, memory 382, input device 383, output device 384 and communication interface 385. The bus 380 may permit communication among the components of user device 300. One skilled in the art would recognize that user device 300 may be configured in a number of other ways and may include other or different elements. For example, user device 300 may also include one or more controllers, modulators, demodulators, encoders, decoders, etc., for processing data.

Processor 381 may include a processor, microprocessor, an application specific integrated circuit (ASIC), field programmable gate array (FPGA) or other processing logic. Processor 381 may execute software instructions/programs or data structures (e.g., which are stored in the memory 382) to control operation of user device 300.

Memory 382 may include a random access memory (RAM) or another type of storage device (e.g., dynamic storage device) that stores information and instructions for execution by processor 381; a read only memory (ROM) or another type of static storage device that stores static information and instructions for use by processor 381; a flash memory (e.g., an electrically erasable programmable read only memory (EEPROM)) device for storing information and instructions; and/or some other type of magnetic or optical recording medium and its corresponding drive.

Memory 382 may also be used to store temporary variables or other intermediate information during execution of instructions by processor 381. Instructions used by processor 381 may also, or alternatively, be stored in another type of computer-readable medium accessible by processor 391. The computer-readable medium (e.g., non-transitory medium) may include one or more memory devices.

The device 300 may also include a motion-sensing device 386 such as an acceleration sensor or an accelerometer embedded in the device 300. The device 300 can also include an antenna 388 coupled to the processor 381 for receiving wireless signals.

The device 300 can optionally include another transceiver for shorter range communications such as a 802.11 transceiver module 388. The device 300 can also include a power source such as a battery 389 which may interface with the bus 380 via a power management integrated circuit (IC) 390.

The power management IC 390 can output regulated voltages and can include an analog to digital (A/D) converter to monitor the voltage of the battery 389. The motion-sensing device 386 can detect a shaking motion of the device 100 which may be used as a functionality setting event, unlocking the phone to a predetermined functionality. The processor 381 can be a microprocessor or microcontroller (MCU) and can process the sensor signal from the motion sensing device 386 to determine if it matched a functionality stored as functionality data in memory 382 to cause the device 300 to be set to the predetermined functionality.

The device 300 may also include a location detection/tracking module 391 which may be used to detect and track a location of the device 300. The location detection/tracking module 391 may include location determination technology that may include global positioning system (GPS) technology, Enhanced-Observed Time Difference (EOTD), WLAN based indoor location, etc., to allow the device 300 to provide detection and tracking of the location of the device 300 through a wide range of environments.

The features of one or more of the event detector 392, controller 393, functionality setting device 394 and functionality change device 395 may be implemented in the processor 381. For example, the functions of these features described above may be performed by using the processor 381 to execute by instructions included in software which is stored on the memory 382.

Alternatively, one or more of these features may be hardware implemented. In this case, for example, the device 300 may include an event detector 392, controller 393, functionality setting device 394 and functionality change device 395, all of which may be connected to other features of the device 300 via the bus 380.

Input device 383 may include mechanisms that permit an operator to input information to user device 300, such as a touchscreen display, microphone, keypad, control buttons, a keyboard (e.g., a QWERTY keyboard, a Dvorak keyboard, etc.), a gesture-based device, an optical character recognition (OCR) based device, a joystick, a touch-based device, a virtual keyboard, a speech-to-text engine, a mouse, a pen, voice recognition and/or biometric mechanisms, etc.

Output device 384 may include one or more mechanisms that output information to the user, including a display (e.g., display 330), a printer, one or more speakers (e.g., speaker 320), etc.

As described above, in an exemplary implementation, display 330 may be a touch screen display. In such an implementation, display 330 may function as both an input device and an output device.

Communication interface 385 may include a transceiver (e.g., any transceiver-like mechanism) that enables user device 300 to communicate with other devices and/or systems. For example, communication interface 385 may include a modem or an Ethernet interface to a LAN. Communication interface 385 may also include mechanisms for communicating via a network, such as a wireless network (e.g., one-on-one communication via a network, communication between more than two entities, etc.).

For example, communication interface 385 may include one or more radio frequency (RF) transmitters, receivers and/or transceivers and one or more antennas for transmitting and receiving RF data via a network.

User device 300 may provide a platform for a user to send and receive communications (e.g., telephone calls, electronic mail messages, text messages, multi-media messages, short message service (SMS) messages, etc.), play music, browse the Internet, or perform various other functions. User device 300, as described in detail below, may also perform processing associated with displaying information via display 330 while in the plurality of functionalities of the device 300. User device 300 may perform these operations in response to the processor 381 executing sequences of instructions contained in a computer-readable medium (e.g., non-transitory medium), such as memory 382. Such instructions may be read into memory 382 from another computer-readable medium via, for example, and communication interface 385.

In alternative embodiments, hard-wired circuitry may be used in place of or in combination with software instructions to implement processes consistent with the present invention. Thus, implementations described herein are not limited to any specific combination of hardware circuitry and software.

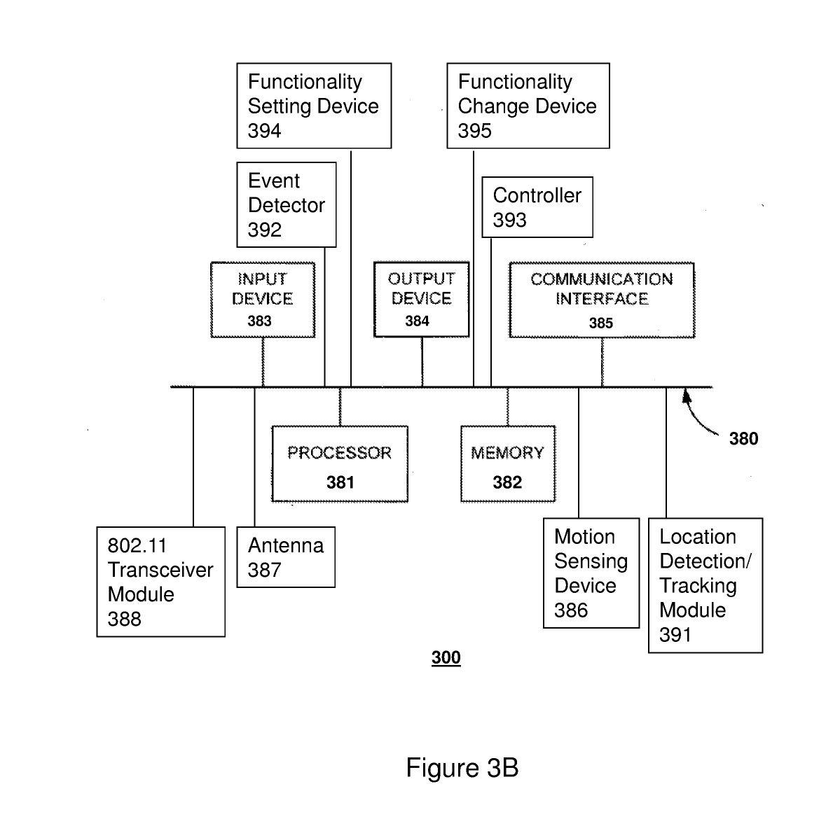

FIGS. 4A-4B illustrate a user device 400 according to another exemplary aspect of the present invention. The user device 400 may include all of the features and functions described above with respect to devices 100 and 300.

As illustrated in FIG. 4A, the user may press the button 405 (e.g., home button) to cause the touchscreen display of the device 400 to display an initial screen 430a. The initial screen 430a may include a virtual Emergency Data button 431. The device 400 may be programmed by the user to display or not display the Emergency Data button 431, for example, by using the settings of the device 400.

In particular, the user may program the device 400 so that the Emergency Data button 431 be displayed for every functionality. That is, the device 400 may be programmed so that the Emergency Data button 431 overrides any lock feature of the device 400, so that the Emergency Data Button 431 is always available to the user on the initial data screen 430a. Alternatively, the user may program the device 400 so that the Emergency Data button 431 is displayed under certain conditions (e.g., only when the device 400 is opened to a predetermined functionality).

Pressing the Emergency Data button 431 may cause the touchscreen of the device 400 to display an Emergency Data Screen (not shown) which displays emergency data (e.g., In Case of Emergency (ICE) data) for the user. Thus, for example, if the user is in an accident or has fallen ill and is unconscious, then emergency personnel may conveniently open the phone, and press the Emergency Data button 431 to access the user's emergency data (e.g., blood type, medicines, allergies, health issues (e.g., high blood pressure), emergency contact phone numbers and e-mail addresses, etc.).

The initial screen 430a may also include a passcode entry screen button (e.g., “Slide to Open” button) 432, which a user can press (e.g., slide) to cause the touchscreen display to display the passcode entry screen 430b illustrated in FIG. 4B. That is, pressing the button 432 may cause the device 400 to enter a functionality setting event detection mode in which the device is prepared to detect a functionality setting event.

For example, in the functionality setting mode, the device may be prepared to receive a passcode input via the passcode input section 433 on the display, fingerprint recognition on the biometric input section 434 of the display, voice recognition using the microphone 460 on the device 400, facial recognition using the image capturing device 470 of the device. The device may also be prepared to detect other types of functionality setting events such as shaking the device, whether the device 400 has left or entered a predetermined geographical location (e.g., using GPS), and so on.

It should be noted that although the functionality setting mode may be entered by pressing the button 432, the device 400 could be programmed to enter functionality setting mode under different conditions. For example, the user could program the device 400 so that the device 400 is continuously in functionality setting mode, with respect to one or more functionality setting events.

In this case, even when the device is in the “off” mode or “sleep” mode, the event detector 1 of the device 400 may be “on” and detecting (e.g., periodically detecting) a functionality setting event. This would allow the user, for example, without opening the device 400 (i.e., without pressing the home button 405) to speak into the microphone 460 and “set” the functionality (i.e., open the device to a predetermined functionality) by using voice recognition.

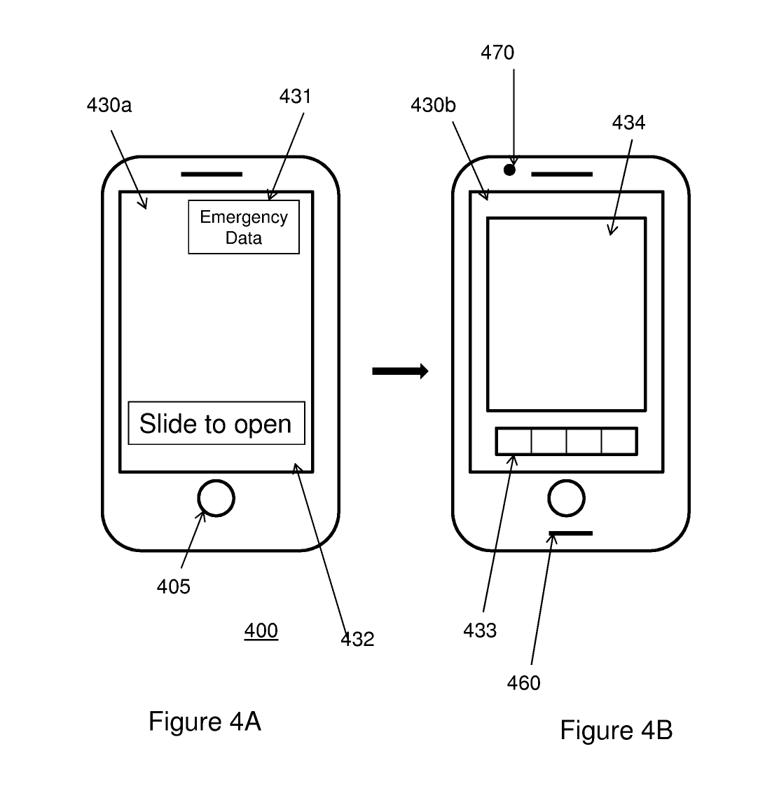

FIG. 5 illustrates functionality data 500, according to an exemplary aspect of the present invention. The functionality data 500 may be stored, for example, in memory device 5 of device 100 or memory device 382 of device 300.

As illustrated in FIG. 5, the functionality data 500 may include a plurality of columns including a Functionality Number column, an “Event Detected to Set the Functionality” column, an Account column which indicates an account associated with a functionality, a Functionality Initiated column and an Operable Features column which may be divided into “Functions Activated” (e.g., Functional Elements Activated) and “Software Applications Accessible”.

Thus, for example, referring to the functionality data 500 in FIG. 5, it can be seen that the user has programmed the device (e.g., device 100, 300, 400, etc.) so that the device can be shaken by the user (e.g., a functionality setting event) in order to open the device to a first functionality (e.g., Functionality Number 1 in FIG. 5), so that the telephone and camera functional elements are operable, and the e-mail app and text message app are operable.

As another example, the device 300 may be programmed by a user so as to set different functionalities based on different types of detected movements. For example, the user may program the device 300 so that a predetermined number of shakes (e.g., two shakes) may cause the setting of a first functionality, whereas a vertical shake followed by two horizontal shakes cause the device 300 to set different functionality.

Further, as indicated for Functionality Number 1 in FIG. 5, the Period for Detecting a Functionality Setting Event is programmed to be “Continuously” so that the user may open the device to a first functionality at any time by shaking the device.

That is, according to the functionality data 500, the user is not required to open the initial display 430a or the passcode entry screen 403b. Instead, if the event detector 1 detects that the user is shaking the device (e.g., which may be detected, for example, by the motion sensing detector 386), the controller 3 may cause the device to open (e.g., automatically open) up and display the user's home screen on the display (e.g., display 330).

As also illustrated in FIG. 5, Jimmy's account (e.g., which is set by the user) is associated with Functionality Number 4 in which the device may be opened by entering “1255” in the passcode entry screen, so that the telephone, camera, the music app, e-mail app, and youtube app are operable. On the other hand Billy's account (e.g., which is also set by the user) is associated with functionality 5 in which the device may be opened by entering “2891” in the passcode entry screen, so that no functional elements are operable, and only the music app and e-mail app are operable.

Other examples of functionalities that may be initiated (e.g., the “Functionality Initiated” column in FIG. 5), may include calling a number automatically, sounding audible alarms or visual alarms; transmitting e-mails, sending a text message.

Other Functionalities include causing the device (e.g., device 100, 300 or 400) to transmit a signal for performing a remote operation, such as turning on a vehicle ignition, opening the door to the car, adjusting the heat/ac of the car, turning on/off the vehicle's defrost feature, setting the vehicle's audio system or allowing the owner of a vehicle to limit (for example) the available horsepower, top speed, duration of use of their vehicle by other drivers. As another example, the functionalities initiated may include causing the device (e.g., device 100, 300 or 400) to transmit a signal for opening the door to the house, turning on the lights in the house, or turning on appliances in the house.

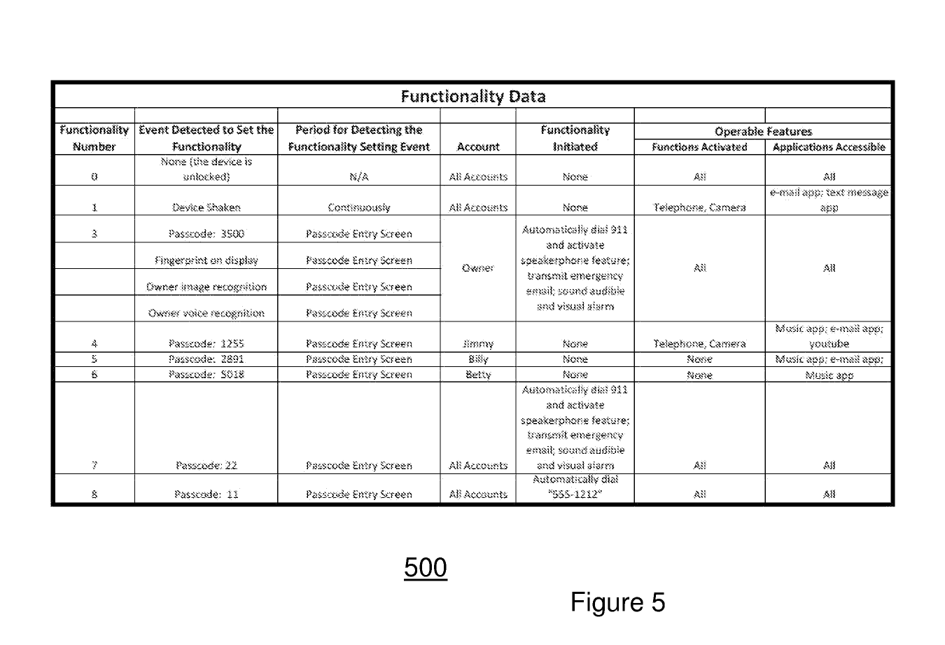

FIG. 6 illustrates a device 600 (e.g., a device having the features of device 100, 300, 400), including a display screen 601 that may be displayed, for example, on a device according to another exemplary aspect of the present invention.

In a conventional device (e.g., mobile terminal), unlocking or starting-up the locked device to activate its full capability is typically the only purpose of the lock screen or password protected function. That is, a lock screen or start-up function for a locked device conventionally has a very limited capability.

In contrast, an exemplary aspect of the present invention may expand the capability of a passcode (e.g., functionality setting code) to include user programmable function codes (e.g., functionality codes).

The exemplary aspects of the present invention may enable the user of the locked device to program or designate significantly more options and functionality by enabling function-based codes to not only unlock or start-up the Locked Device and/or additional functionality but also to lock the lockable or securable device in various programmable states of user-enabled functions in a secured mode.

For example, the code (e.g., functionality setting event) can be programmed by the user such that once it completes a function it leaves the device in a “locked mode” or “unlocked mode”. For example, the user may program the device so that entering passcode “101” (e.g., command 101) might cause the device to speed dial a first phone number and then return to locked mode, whereas entering passcode “201” (e.g., command 201) might cause the device to “speed text” the first phone number (e.g., speed dial a text message to the first phone number) and then leave the device in an unlocked mode.

In an exemplary embodiment, the present invention may enable the user to program the lock screen on the locked device via user-defined Functionality Codes such that the user could not only unlock or lock the locked device but could also simultaneously initiate other functionality or applications (App) such as (but not limited to) enhanced device or user security, embedded applications, stealth emergency aid requests or other virtually any other user application defined function.

This may also enable the user of the locked device to lock or unlock with specific or limited functionality while simultaneously putting the majority of the locked device applications or functionality in a locked or unlocked state.

FIG. 6 illustrates a traditional numeric, symbol, biometric, symbol, swipe or voice based lock screen 601 for a touch screen or keypad mobile device such as cell phones and tablet computing devices. In particular, FIG. 6 illustrates a mobile device 600 (e.g., cell phone, smart phone, mobile computing device, etc.), and a start-up or unlock screen 601 which is displayed on the display of the mobile device 600.

As illustrated in FIG. 6, the lock screen 601 includes a Passcode Prompt 602 that may direct the user to “enter passcode,” “unlock device” or some other command to start-up or unlock mobile device 600, including biometric, trace symbol or voice based security protocols. The lock screen 601 also includes Passcode Entry Input 603 which may include a number (four is often used) of input blocks for user input of a user selected Passcode.

For example, the user may program the device so that if the fingerprint of a first user is detected, then device might speed dial a second phone number and then return to locked mode, whereas if the fingerprint of a second user is detected, the device might “speed text” the second phone number (e.g., speed dial a text message to the first phone number) and then leave the device in an unlocked mode.

The lock screen 601 also includes Passcode Entry Keypad 604 which may include a numeric or alphanumeric keypad (e.g., similar to telephone keypad) including numbers or a combination of numbers and letters. The term “alphanumeric keypad” should be construed herein to mean a keypad including any type of characters or combination or characters (e.g., numbers only, letters only, other characters only or any combination of these).

The screen 601 may be used as part of a power-up or start-up screen or as an unlock screen if the mobile device 600 has gone into sleep mode or secure mode.

In another exemplary embodiment the user could use different voice commands or tracing specific symbols on the screen of mobile device 600 to open or secure the mobile device 600 with specific parameters or App functionality.

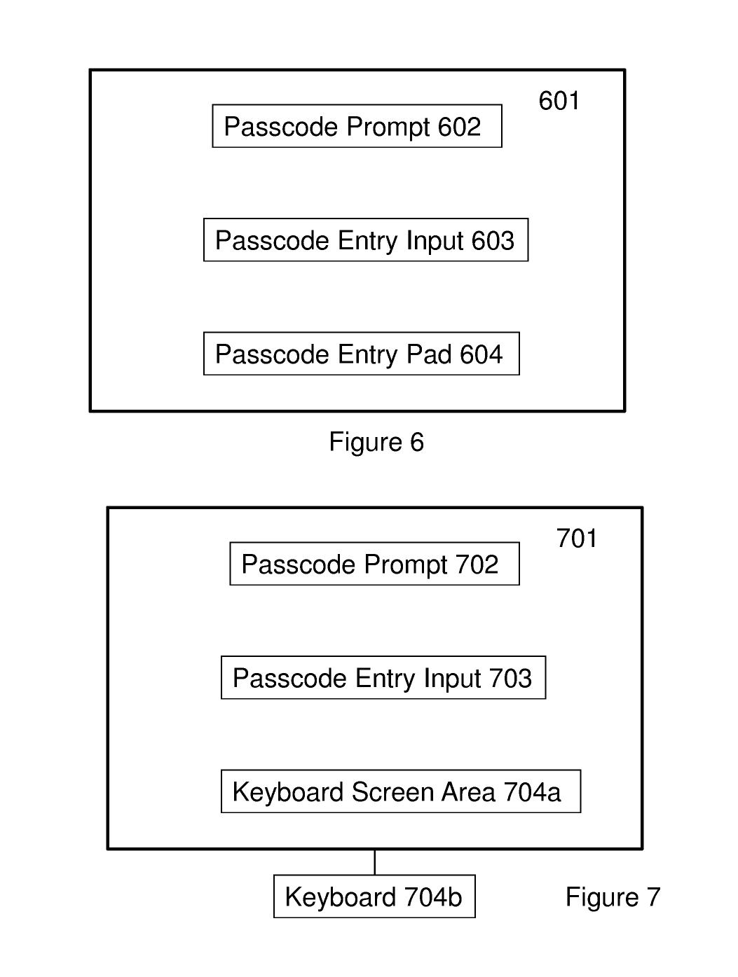

FIG. 7 illustrates a device 700 (e.g., a device having the features of device 100, 300, 400), according to another exemplary aspect of the present invention.

As illustrated in FIG. 7, the device 700 includes a password, biometric, symbol, swipe or voice based lock screen 701 for a personal computer or keyboard or touch screen enabled device. That is, the device 700 may include a typical personal computer or “keyboard input” based device. The device 700 may include a start-up screen which allows a user to unlock the personal computer with a previously user-defined password.

The Prompt 702 may direct the user to “enter password,” “unlock device” or some other command to start-up or unlock the device 700. Password Entry Block 703 may include a block for displaying user input of a user-selected Password.

Password Entry Keyboard Screen 704a is “virtual” keyboard (e.g., a touch screen alpha, numeric and trace symbol keyboard) which is displayed on the screen 701 or display (such as Qwerty type keyboard). The device 700 may also utilize (separately or in addition to 704a) a physical Password Entry Keyboard 704b which is typically a connected (wired or wireless) alpha, numeric and symbol keyboard connected to the device 700 (e.g., a Qwerty type keyboard).

The screen 701 may be used as a power-up or start-up screen or as an unlock screen if the mobile device 700 has gone into off, sleep or secure mode.

In another exemplary embodiment the user could use different voice commands or tracing specific symbols on the screen of device 700 to open or secure the device 700 with specific parameters or App functionality.

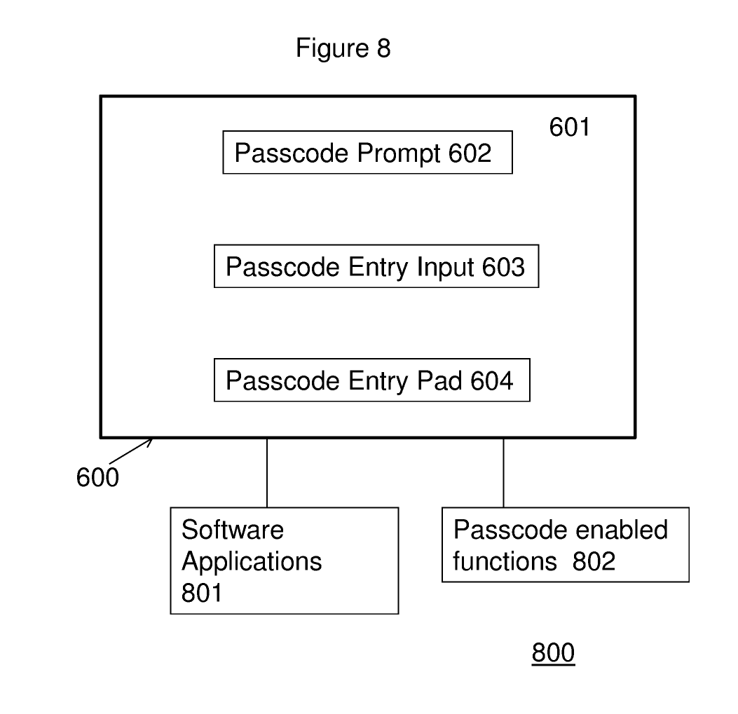

FIG. 8 illustrates a device 800 (e.g., a device having the features of device 100, 300, 400 or 600), according to another exemplary aspect of the present invention.

As illustrated in FIG. 8, the device 800 may include a Functionality Code-enabled mobile device, or any device that uses a number pad and/or symbol or number pad and/or symbol representation including biometric, symbol, swipe or voice based passcode entry system. In FIG. 3, is shown a mobile device (e.g., cell phones, smart phone, mobile computing devices, etc.) and start-up or unlock screen mobile device 600.

In an exemplary embodiment, the device 600 may include a software or hardware mobile device application 801 added as a software application (“App”), software embedded in the device firmware or an attached hardware add-on to the mobile device 600, which may enable user-selectable function or speed codes for increased or specific functionally associated with the passcode to be entered with the Passcode Entry Input 603.

When the user enables functions via the programmable function or speed codes, different functions or applications may be enabled during the secure or sleep mode or a specific function/application may be enabled in the start-up, wake-up or unsecure mode. This functionality or application is represented by the Passcode Enabled Functions 802 in the device 800.

The Passcode Enabled Functions 802 may include (but are not limited to):
1. Security Functions (one or more digits, typically 4 or less): Stealth emergency call and track, Secure on drop (shock), Track phone, Disable contacts or any App, Play dead, Etc. For example, Speed Code “911” could call police with an emergency request for help and track mobile device info and be completely invisible to an attacker”.
2. Speed Codes (one or more digits, typically four (4) or less): speed dial of contacts, web page access, enable, disable or hide Apps, etc. For example, Speed Code “11” could call contact number 555-555-5555. As another example, Speed Code “22” could open voice command controls on the device 800.
3. Functionality Codes (one or more digits, typically 8 or less, but could be programmed for up 16 digits): Enable specific set of Apps, Programming mode, Pairing mode (provides larger screen programming on another enabled device), etc. For example the Speed Code “12345678” could open a user programming mode.

In another exemplary embodiment, the present invention may utilize an application code directory for Mobile Application Developers to register and/or pre-code aspects of their App and to provide a more coordinated functionality and functionality code access for users of the present invention and App developers. Any mobile application developer can register their application with the present invention application database manager and be assigned a unique 1 in 10 billion code (called a Universal Application Code or “UAC”). The table allows the locked device and a Remote Device (that is given permission) to set up and edit the Speed Codes for different functions on the locked device.

Another method is for the user to define a Speed Code when the application or program is initially downloaded. When the application or program is downloaded then the application or program developer can have the application ask the user for a Speed Code during the download process. The functionality described in FIG. 8 could also be enabled using biometric, voice or trace symbol commands or codes.

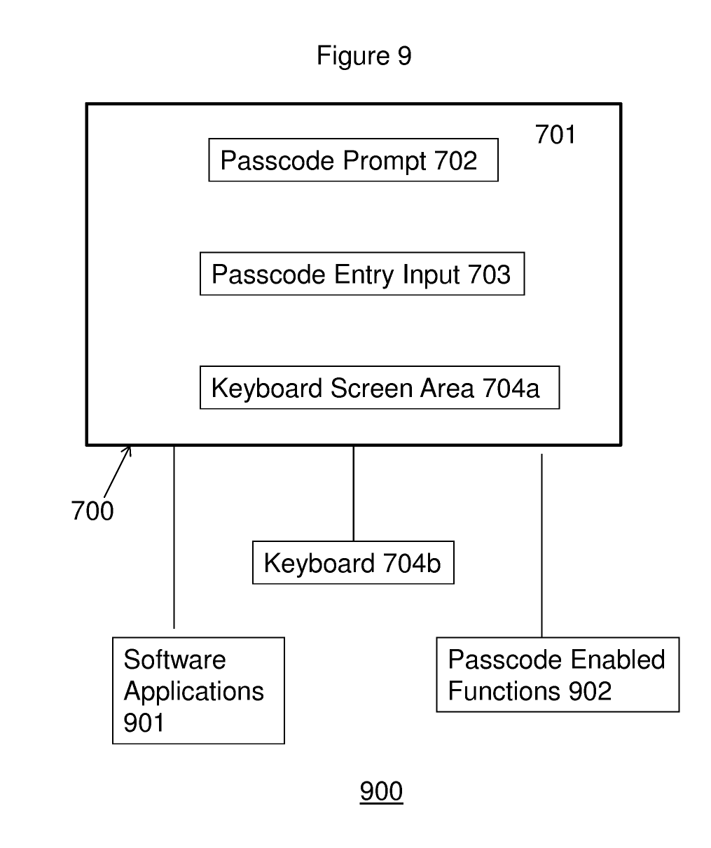

FIG. 9 illustrates a device 900 (e.g., a device having the features of device 100, 300, 400, 700), according to another exemplary aspect of the present invention.

The device 900 may include an exemplary Functionality Code enabled computing device or any device that uses a keyboard or alphanumeric representation password or passcode including biometric, symbol or voice based entry system.

In particular, the device 900 in FIG. 9 may include a typical personal computer or “keyboard input” based device 700.

The device 900 also includes software applications 901 (e.g., software or hardware applications), software embedded in the device firmware or an attached hardware add-on to the device 700 to enable user selectable functions or speed codes for increased or specific functionally associated with Password Entry Input 703. When the user enables functions via the programmable function or speed codes, different functions or applications are enabled during the secure or sleep mode or a specific function/applications are enabled in the start-up, wake-up or unsecure mode. This functionality or application(s) are represented by Passcode Enabled Functions 902.
The Password Enabled Functions 902 may include (but not limited to):
1. Security Functions (one or more of alpha, numeric, symbol or biometric password): Stealth emergency notify, Secure (or partial secure), Disable specific Apps or programs, Play dead, etc. For example—Speed Code “EMR1” could contact police or security with an emergency request for help and user info and be completely invisible to an attacker.
2. Speed Codes (one or more of alpha, numeric, symbol or biometric password): speed access of contacts, web page access, file access, enable, disable or hide apps, etc. For example, Speed Code “Z*” could launch specific web page using specific browser. For example, Speed Code “$a” could open a specific excel file.
3. Functionality Codes (one or more digits, typically 8 or less, but could be programmed for up 16 alpha, numeric or symbol spaces): Enable specific set of Apps, Programming mode, etc. For example—Speed Code “Mywork@4” could open user scheduled files, programs, applications and an interactive website for a web based video conference.

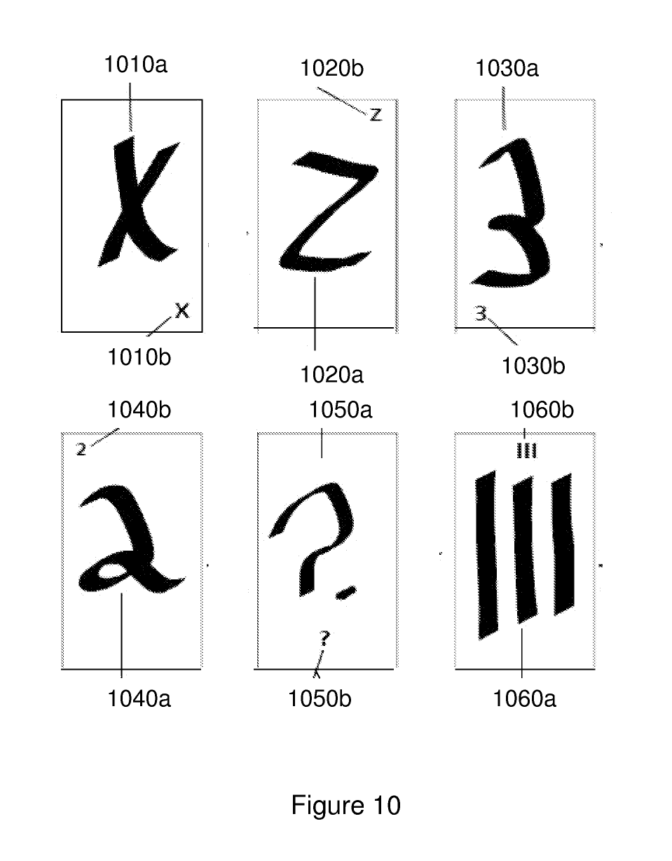

FIG. 10 illustrates six examples 1010, 1020, 1030, 1040, 1050 and 1060 of an exemplary Trace Symbol input methodology for a device (e.g., a device having the features of device 100, 300, 400, 600 or 700), according to another exemplary aspect of the present invention.

In particular, the six examples 1010, 1020, 1030, 1040, 1050 and 1060 of an exemplary User Definable Trace Symbol input methodology may be used in a Functionality Code enabled mobile device, computing or any device that uses a touch screen input for password or passcode. For example, the examples in FIG. 5 may be used on a touch screen mobile device (e.g., cell phones, smart phone, mobile computing devices, etc.), device 600 (e.g., start-up or unlock screen mobile device) or device 700 (e.g., a touch screen personal computer or touch screen based device).

In an exemplary embodiment, device 600 (e.g., mobile device) or device 700 (e.g., keyboard device) includes a software or hardware Trace Symbol Application added as a software application (“APP”), so that a trace symbol (e.g., trace symbol 1010, 1020, 1030, 1040, 1050 and 1060) may be enable a functionality of the device 600 or device 700. That is, software embedded in the device firmware or an attached hardware add-on to the device 600 (e.g., mobile device) or device 700 (e.g., Keyboard Device) may enable user-selectable function or speed symbols for increased or specific functionally associated with lock, secure, unlock or unsecure capability. When the user enables functions via the Trace Symbol Application of device 600 or device 700, different functions or applications may be enabled during the secure or sleep mode or a specific function/applications are enabled in the start-up, wake-up or unsecure mode.

The user of the Trace Symbol Application of device 600 or device 700 simply enters a number, letter, symbol or shape (known by device or learned by device) by tracing the symbol on the touch screen of the enabled device 600 or device 700 with their finger or a “wand” type input pen Trace Symbol 1010a-1060a. The enable device may confirm with the user what the Trace Symbol Application in the device 600 or the device 700 recognizes as the user trace symbol input.

It should be noted that the functionality setting event (e.g., functionality setting code) could include a combination of types of inputs. For example, a combination of a voice recognition input and detection location, or a combination of motion detection (e.g., shaking the device) and passcode entry.

In one exemplary embodiment, the functionality setting event may include entry of a trace symbol combined with a biometric reading. For example, if the user uses his right hand forefinger to trace the number 7, this may cause the device to set a first functionality (e.g., a first security level), whereas if the user uses his second finger to trace the letter N, this may cause the device to set a second functionality (e.g., a second security level which is more or less secure than the first security level).

The display on the device 600 and device 700 also displays a confirmation 1010b-1060b of the Trace Symbol 1010a-1060a at a location of the touch screen (e.g., a predetermined location or a location that is least populated or set by user). The user can confirm the correct or reject the enabled device interpretation of the trace symbol and program a number of options to accept or deny the trace symbol input, including (but not limited to) an accept time (with no other user input), a designated number of taps for accept or deny or other programmable options.

The user may also program the device 600 or device 700 to go set the functionality associated with the Trace Symbol. That is, the entry of the Trace Symbol is a functionality setting event causing the device 600 or device 700 to set the functionality associated with the Trace Symbol.

In one exemplary embodiment, the present invention (e.g., device 600 or device 700) may be programmed by the user so that “tapping” on the phone, for example, with the user's finger may be a functionality setting event. This would allow the user, for example, to “tap in a command” (i.e., set a functionality by tapping). For example, the user could program the device so that if the user taps a “dot dot dash” the device would cause a first functionality to be set, whereas if the user taps “dash dot dash” the device would cause a second functionality to be set.

Further, as noted above, the user could program the device so that such a “tap in command” feature may be combined with another functionality setting event (e.g., a biometric functionality setting event such as fingerprint recognition). Thus, for example, a first user tapping in “dot dash dot” may cause a first functionality to be set, whereas a second user tapping in “dot dash dot” may cause a second functionality to be set.

By way of example: The Trace Symbol Application is demonstrated by the following (but not limited to):

1. The user inputs a Trace Symbol 1010a of an “X” and the enabled device may display a confirmation “X” as the enabled device translation Trace Symbol Confirmation 1010b. The user then may simply visually confirm the enabled device interpretation and do nothing, which after a user programmed time the enable device will enable the corresponding functionality, or program an input variable such as number of touch screen “taps” to accept or deny the enabled device interpretation.

2. The user inputs a Trace Symbol 1020a of a “Z” and the enabled device may display a confirmation “Z” as the enabled device translation Trace Symbol Confirmation 1020b. The user then may simply visually confirm the enabled device interpretation and do nothing, which after a user programmed time the enable device will enable the corresponding functionality, or program an input variable such as number of touch screen “taps” to accept or deny the enabled device interpretation.

3. The user inputs a finger Trace Symbol 1030a of a “3” and the enabled device may display a confirmation “3” as the enabled device translation Trace Symbol Confirmation 1030b. The user then may simply visually confirm the enabled device interpretation and do nothing, which after a user programmed time the enable device will enable the corresponding functionality, or program an input variable such as number of touch screen “taps” to accept or deny the enabled device interpretation.

4. The user inputs a Trace Symbol 1040a of a “2” and the enabled device may display a confirmation “2” as the enabled device translation Trace Symbol Confirmation 1040b. The user then may simply visually confirm the enabled device interpretation and do nothing, which after a user programmed time the enable device will enable the corresponding functionality or program an input variable such as number of touch screen “taps” to accept or deny the enabled device interpretation.

5. The user inputs a less clear Trace Symbol 1050a of a “2” and the enabled device may display a Trace Symbol Confirmation 1050b of “?” as the enabled device translation of the Trace Symbol 1050a. The user seeing their Trace Symbol 1050a was not recognized may use the designated reject input such as number of taps and then re-input the Trace Symbol 1040a of a “2” and only confirm when then enabled device shows a proper designation of Trace Symbol Confirmation 1040b of a “2” as the enabled device's interpretation.

The user then may simply visually confirm the enabled device interpretation and do nothing, which after a user programmed time the enable device will enable the corresponding functionality or program an input variable such as number of touch screen “taps” to accept or deny the enabled device interpretation.

6. The user may use pure symbols or shapes too, such as: The user inputs a Trace Symbol 1060a of three vertical lines “III” and the enabled device may display a confirmation “III” as the enabled device translation Trace Symbol Confirmation 1060b. The user then may simply visually confirm the enabled device interpretation and do nothing, which after a user programmed time the enable device will enable the corresponding functionality or program an input variable such as number of touch screen “taps” to accept or deny the enabled device interpretation.

In another exemplary embodiment, the present invention may utilize an application code directory for Mobile Application Developers to register and/or pre-code aspects of their App and to provide a more coordinated functionality and functionality code access for users of the present invention and App developers. Any mobile application developer can register their application with the present invention application database manager and be assigned a unique 1 in 10 billion code (called a Universal Application Code or “UAC”).

The table allows the Locked Device and a Remote Device (that is given permission) to set up and edit the Speed Codes for different functions on the Locked Device. Another method is for the user to define a Speed Code when the application or program is initially downloaded.

When the application or program is downloaded then the application or program developer can have the application then ask the user for a Speed Code during the download process. The functionality described in FIG. 3 could also be enabled using biometric, voice or trace symbol commands or codes.

In another exemplary embodiment, the present invention utilizes an application code directory for Keyboard Application Developers to register and pre-code aspects of their App and to provide more coordinated functionality and functionality code access to users of the present invention and App providers. Any keyboard application developer can register their application with the present invention application database manager and be assigned a unique 1 in 10 billion code (called a Universal Application Code or “UAC”).

The table allows the Locked Device and a Remote Device (that is given permission) to set up and edit the Speed Codes for different functions on the Locked Device. Another method is for the user to define a Speed Code when the application or program is initially downloaded.

When the application or program is downloaded then the application or program developer can have the application then ask the user for a Speed Code during the download or install process. The functionality described in FIG. 4 could also be enabled using biometric, voice or trace symbol commands or codes.

In summary, the present invention may be used to increase the functionality of a lock, unlock, start-up or secure, suspend or shutdown screen devices which utilize a passcode or password, biometric, voice, symbol, swipe or trace symbol security protocol, such as: cell phones, smart phones, mobile computing devices, personal computers or any device that utilizes a lock or unlock screen or secure device functionality that activates, reactivates, starts-up or secures, suspends or shuts down the device with the input of a passcode, password or switch, button, touch screen or any other functionality input system.

In particular, the present invention may provide a system for devices which use a passcode or password security protocol, such as (but not limited to): cell phones, smart phones (iPhone, Android, Galaxy, etc.), mobile computing devices (iPad, Kindle, Surface and Android tablets, etc.), personal or laptop computers, or any other device which uses a numeric keypad, keyboard, biometric, voice or trace symbol for user input to expand the functionality of the passcode or password to initiate applications, access, state/status and program functionality with one entry step on the Locked Device or Lockable Device by entering user-defined Functionality Codes.

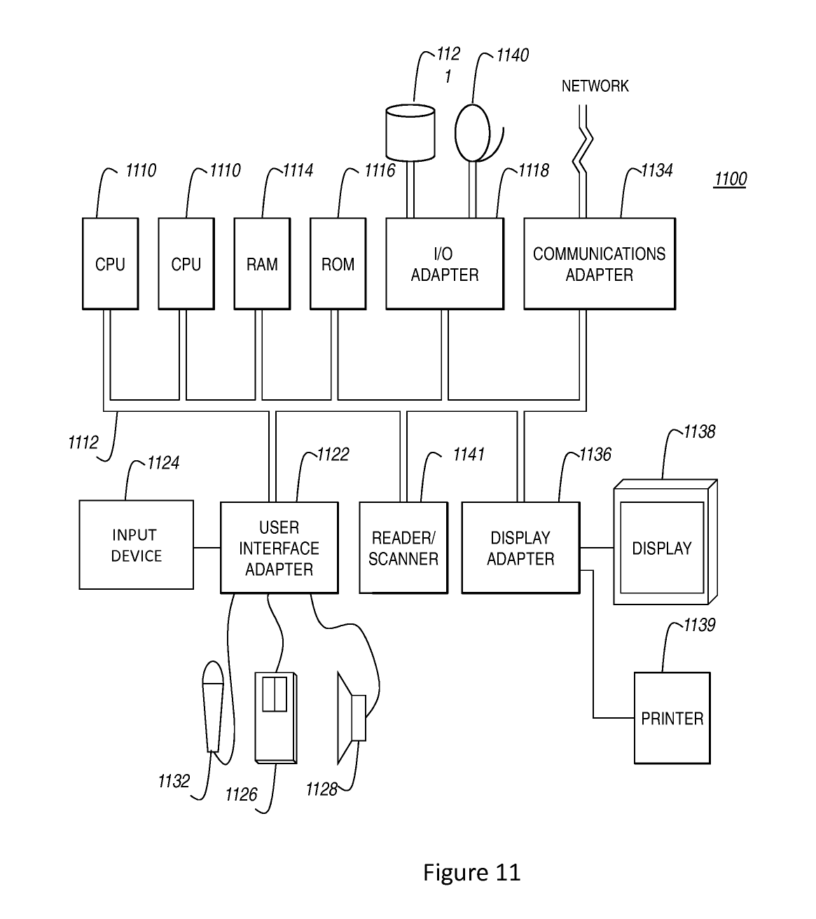

Referring now to FIG. 11, system 1100 illustrates a typical hardware configuration which may be used for implementing the device (e.g., device 100, 300, 400, 600, 700) and method (e.g., method 200) of the present invention. The configuration has preferably at least one processor or central processing unit (CPU) 1111. The CPUs 1111 are interconnected via a system bus 1112 to a random access memory (RAM) 1114, read-only memory (ROM) 1116, input/output (I/O) adapter 1118 (for connecting peripheral devices such as disk units 1121 and tape drives 1140 to the bus 1112), user interface adapter 1122 (for connecting a keyboard 1124, mouse 1128, speaker 1128, microphone 1132, pointing stick 1127 and/or other user interface device to the bus 1112), a communication adapter 1134 for connecting an information handling system to a data processing network, the Internet, an Intranet, a personal area network (PAN), etc., and a display adapter 1136 for connecting the bus 1112 to a display device 1138 and/or printer 1139. Further, an automated reader/scanner 1141 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 1111 to execute a sequence of machine-readable instructions. These instructions may reside in various types of signal bearing media.

Thus, this aspect of the present invention is directed to a programmed product, including signal-bearing media tangibly embodying a program of machine-readable instructions executable by a digital data processor incorporating the CPU 1111 and hardware above, to perform the method of the invention.

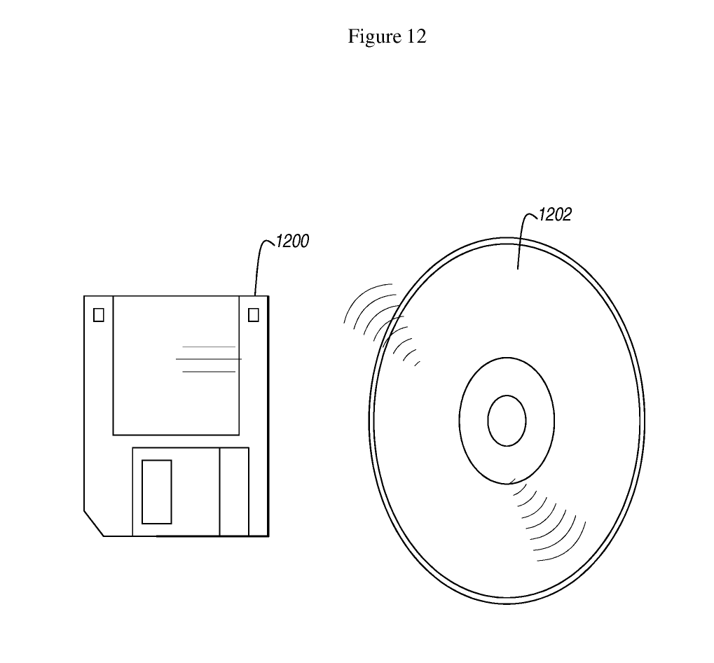

This signal-bearing media may include, for example, a RAM contained within the CPU 1111, as represented by the fast-access storage for example. Alternatively, the instructions may be contained in another signal-bearing media, such as a magnetic data storage diskette 1200 or compact disc 1202 (FIG. 12), directly or indirectly accessible by the CPU 1111.

We note that the storage media illustrated in FIG. 12 should not be considered limiting. Indeed, any type of storage media may be used, including random access, read-only and compact disc. In addition, the present invention may use a storage media technology which is developed after the present invention.

Whether contained in the computer server/CPU 1111, or elsewhere, the instructions may be stored on a variety of machine-readable data storage media, such as DASD storage (e.g, a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable storage media. In an illustrative embodiment of the invention, the machine-readable instructions may include software object code, compiled from a language such as C, C++, etc.

With its unique and novel features, the present invention provides a device in which functionalities are more easily enabled as compared to conventional devices.

While the invention has been described in terms of one or more embodiments, those skilled in the art will recognize that the invention can be practiced with modification within the spirit and scope of the appended claims. Specifically, one of ordinary skill in the art will understand that the drawings herein are meant to be illustrative, and the design of the inventive device is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A device including a plurality of functionalities, comprising:
an event detector for detecting a functionality setting event;
a functionality setting device for referring to functionality data and setting a first functionality of the plurality of functionalities based on the functionality data; and
a controller for controlling a feature associated with the first functionality to be operable in response to the setting of the first functionality.

2. The device of claim 1, further comprising:
a memory device for storing the functionality data, the functionality data associating the detected functionality setting event with the first functionality, and associating the first functionality with the feature.

3. The device of claim 1, wherein the functionality data associates the first functionality with a plurality of features of the device.

4. The device of claim 1, further comprising:
a plurality of features including the feature,
wherein the plurality of features includes a plurality of functional elements and a plurality of software applications.

5. The device of claim 4, wherein the plurality of functional elements comprises at least one of a display element, a camera element, a telephone element, a flashlight element, a speaker element, a microphone element and a location determination element.

6. The device of claim 4, wherein the functionality data associates a plurality of functionality setting events with the plurality of features.

7. The device of claim 6, wherein the plurality of functionality setting events comprises at least one of entering a passcode, fingerprint recognition, voice recognition, facial recognition, shaking the device, entry of a user-definable trace symbol, the device leaving a geographical location and the device entering a geographical location.

8. The device of claim 4, wherein the plurality of software applications comprises at least one of an Internet browser application, a music application, a calendar application, a mapping application, a settings application, an e-mail browser application, a weather application and a calculator application.

9. The device of claim 1, wherein the functionality data comprises user programmable functionality data.

10. The device of claim 1, wherein the event detector detects a functionality change event, and the functionality data associates the detected functionality change event with a second functionality of the plurality of functionalities.

11. The device of claim 10, further comprising:
a functionality change device for referring to the functionality data to change the functionality of the device from the first functionality to the second functionality, in response to the event detector detecting the functionality change event.

12. The device of claim 10, wherein the functionality data associates the second functionality with an other feature of the device.

13. The device of claim 12, wherein the controller controls the second feature to be operable, in response to the functionality change device changing the functionality of the device to the second functionality.

14. The device of claim 1, further comprising:
a display device for displaying a functionality data manipulating screen which includes a functionality input section, a functionality change event input section, an account input section, and an operable feature input section.

15. A method of operating a device including a plurality of functionalities, comprising:
detecting a functionality setting event;
referring to functionality data and setting a first functionality of the plurality of functionalities based on the functionality data; and
controlling a feature associated with the first functionality to be operable in response to the setting of the first functionality.

16. The method of claim 15, further comprising:
storing the functionality data, the functionality data associating the detected functionality setting event with the first functionality, and associating the first functionality with the feature.

17. The method of claim 15, wherein the functionality data associates the first functionality with a plurality of features of the device, and
wherein the device includes a plurality of features including a plurality of functional elements and a plurality of software applications.

18. The method of claim 15, further comprising:
detecting a functionality change event, the functionality data associating the detected functionality change event with a second functionality of the plurality of functionalities; and
referring to the functionality data to reset the device from the first functionality to the second functionality, in response to the event detector detecting the functionality change event.

19. The method of claim 15, further comprising:
displaying a functionality data manipulating screen which includes a functionality input section, a functionality change event input section, an account input section, and an operable feature input section.

20. A programmable storage medium tangibly embodying a program of machine-readable instructions executable by a digital processing apparatus to perform a method of operating a device including a plurality of functionalities, the method comprising:
detecting a functionality setting event;
referring to functionality data and setting a first functionality of the plurality of functionalities based on the functionality data; and
controlling a feature associated with the first functionality to be operable in response to the setting of the first functionality.
